(19) United States
(12) Patent Application Publication
(10) Pub. No.: US 2016/0306056 A1
(43) Pub. Date: Oct. 20, 2016

(54) TEMPERATURE CORRECTION SYSTEM AND METHOD FOR X-RAY DETECTOR

(71) Applicant: General Electric Company, Schenectady, NY (US)

(72) Inventors: Yunfeng Sun, Beijing (CN); Guanying Nie, BeiJing (CN); Ke Sun, BeiJing (CN)

(21) Appl. No.: 15/099,805

(22) Filed: Apr. 15, 2016

(30) Foreign Application Priority Data
Apr. 17, 2015 (CN) 201510186055.0

(51) Int. Cl. G01T 7/00

(52) U.S. Cl. CPC G01T 7/005

(57) ABSTRACT

The present invention provides temperature correction system and method for X-ray detector. The method comprises: obtaining offset data of pixel units of the X-ray detector at a current temperature; subtracting calibration offset data of each pixel unit at a preset temperature from the offset data of the pixel unit at the current temperature to obtain a current offset data increment of each pixel unit; obtaining X-ray response data of each pixel unit with a preset scanning parameter at the current temperature; obtaining a current X-ray response data increment of each pixel unit based on a pre-stored transform function, wherein the transform function uses the current offset data increment of each pixel unit and the X-ray response data of each pixel unit at the current temperature as independent variables, and uses the current X-ray response data increment of each pixel unit as a dependent variable; and obtaining corrected X-ray response data of each pixel unit by subtracting the current X-ray response data increment of each pixel unit from the X-ray response data of each pixel unit at the current temperature.

### CROSS REFERENCE TO RELATED APPLICATIONS

This application claims priority under 35 U.S.C. §§119(a)-(d) or (f) to prior-filed, co-pending Chinese patent application number 201510186055.0 filed Apr. 17, 2015 and titled temperature correction system and method for x-ray detector, which is hereby incorporated by reference in its entirety.

### BACKGROUND

The present invention relates to a field of X-ray detector, particularly to a system and method for temperature correction of an X-ray detector used in medical treatment and industry (e.g., CT detector, X-ray flat panel detector, industrial CT detector, industrial X-ray flat panel detector, photo diode array detector).

In an X-ray detecting device, an X-ray detector (e.g., CT detector, X-ray flat panel detector) is a very important component, whose performance tremendously affects the imaging quality. The X-ray detector is used to convert the X-rays penetrating an object to be detected into electric signals. Generally, the detector includes a photo diode module converting the optical signals into electrical analog signals and a scintillator module converting the X-rays into optical signals. Furthermore, the detector also includes a data acquisition system (DAS), which is used to convert the above electrical analog signals into digital signals. The conventional DAS and photo diode module are separated, but in recent years, people have been trying to integrate them together, and a detector with such a structure is referred to as DoD detector.

Since a chip for integrating the photo diode module and DAS is a semiconductor material silicon, a shift in the response signals will be generated as the temperature changes, resulting in artifacts appearing on images. In order to eliminate the shift and the artifacts on the images, the usual method is to keep the temperature constant, which needs to add a specific temperature control structure on the detector, however, the cost for such structure is very high. Or, a temperature sensor is additionally installed inside the detector to detect the temperature change and make the temperature correction; however, for this method, the cost is increased, the error between the detected temperature and the actual temperature is very large, time lag exists, and the temperature differences between each of the pixel units cannot be reflected, therefore, the correction effect is not good enough.

Accordingly, in order to solve the problem of temperature shift in image signals of the X-ray diagnosis device, there is a need to provide a novel system and method for temperature correction of an X-ray detector.

### SUMMARY

Exemplary embodiments of the present invention provide a temperature correction system for an X-ray detector, comprising: a offset data obtaining module, a offset data increment obtaining module, a transforming module, an X-ray response data obtaining module and a correcting module. The offset data obtaining module is used to obtain offset data of pixel units of the X-ray detector at a current temperature; the offset data increment obtaining module is used to subtract calibration offset data of each pixel unit at a preset temperature from the offset data of the pixel unit at the current temperature to obtain a current offset data increment of each pixel unit; the X-ray response data obtaining module is used to obtain X-ray response data of each pixel unit with a preset scanning parameter at the current temperature; the transforming module obtains a current X-ray response data increment of each pixel unit based on a pre-stored transform function, wherein the transform function uses the current offset data increment of each pixel unit and the X-ray response data of each pixel unit at the current temperature as independent variables, and uses the current X-ray response data increment of each pixel unit as a dependent variable; the correcting module obtains corrected X-ray response data of each pixel unit by subtracting the current X-ray response data increment of each pixel unit from the X-ray response data of each pixel unit at the current temperature.

The exemplary embodiments of the present invention also provide a temperature correction method for an X-ray detector, comprising: obtaining offset data of pixel units of the X-ray detector at a current temperature; subtracting calibration offset data of each pixel unit at a preset temperature from the offset data of the pixel unit at the current temperature to obtain a current offset data increment of each pixel unit; obtaining X-ray response data of each pixel unit with a preset scanning parameter at the current temperature; obtaining a current X-ray response data increment of each pixel unit based on a pre-stored transform function, wherein the transform function uses the current offset data increment of each pixel unit and the X-ray response data of each pixel unit at the current temperature as independent variables, and uses the current X-ray response data increment of each pixel unit as a dependent variable; and obtaining corrected X-ray response data of each pixel unit by subtracting the current X-ray response data increment of each pixel unit from the X-ray response data of each pixel unit at the current temperature.

The exemplary embodiments of the present invention also provide a temperature correction system for an X-ray detector, comprising a offset data obtaining module, an X-ray response data obtaining module and a correcting module. The offset data obtaining module is used to obtain offset data of pixel units of the X-ray detector at a current temperature; the X-ray response data obtaining module is used to obtain X-ray response data of each pixel unit with a preset scanning parameter at the current temperature; the correcting module is used to obtain corrected X-ray response data of each pixel unit based on a pre-stored transform function; the transform function is: gain′=gain−f′ (gain, offset), wherein gain′ is the corrected X-ray response data of each pixel unit, “gain” is the X-ray response data of each pixel unit at the current temperature, “offset” is the offset data of each pixel unit at the current temperature.

The exemplary embodiments of the present invention also provide a temperature correction method for an X-ray detector, comprising: obtaining offset data of pixel units of the X-ray detector at a current temperature; obtaining X-ray response data of each pixel unit with a preset scanning parameter at the current temperature; obtaining corrected X-ray response data of each pixel unit based on a pre-stored transform function; the transform function is: gain′=gain−f′ (gain, offset), wherein gain′ is the corrected X-ray response data of each pixel unit, “gain” is the X-ray response data of each pixel unit at the current temperature, “offset” is the offset data of each pixel unit at the current temperature.

Other features and aspects will become apparent from the detailed description, the accompanying drawings and claims that follow.

### BRIEF DESCRIPTION OF THE DRAWINGS

The present invention can be understood better in light of the description of exemplary embodiments of the present invention with reference to the accompanying drawings, in which:

FIG. 1 is a block diagram of a system for temperature correction of an X-ray detector provided by one embodiment of the present invention;

FIG. 2 is a schematic diagram showing that offset data of each pixel unit of the X-ray detector changes as the temperature of the pixel unit changes;

FIG. 3 is a schematic diagram showing that X-ray response data of each pixel unit of the X-ray detector changes as the temperature of the pixel unit changes;

FIG. 4 is a block diagram of a system for temperature correction of an X-ray detector provided by another embodiment of the present invention;

FIG. 5 is a block diagram of a system for temperature correction of an X-ray detector provided by another embodiment of the present invention;

FIG. 6 is a flow chart of a method for temperature correction of an X-ray detector provided by one embodiment of the present invention;

FIG. 7 is a flow chart of obtaining a transform function before Step S64 in FIG. 6;

FIG. 8 is a flow chart of a method for temperature correction of an X-ray detector provided by another embodiment of the present invention;

FIGS. 9A-9E are comparison diagrams between images obtained after temperature correction using the above system and method for temperature correction of an X-ray detector and images obtained after conventional temperature correction.

### DETAILED DESCRIPTION

Hereafter, a detailed description will be given for preferred embodiments of the present invention. It should be pointed out that in the detailed description of the embodiments, for simplicity and conciseness, it is impossible for the Description to describe all the features of the practical embodiments in details. It should be understood that in the process of a practical implementation of any embodiment, just as in the process of an engineering project or a designing project, in order to achieve a specific goal of the developer and in order to satisfy some system-related or business-related constraints, a variety of decisions will usually be made, which will also be varied from one embodiment to another. In addition, it can also be understood that although the effort made in such developing process may be complex and time-consuming, some variations such as design, manufacture and production on the basis of the technical contents disclosed in the disclosure are just customary technical means in the art for those of ordinary skilled in the art relating to the contents disclosed in the present invention, which should not be regarded as insufficient disclosure of the present invention.

Unless defined otherwise, all the technical or scientific terms used in the Claims and the Description should have the same meanings as commonly understood by one of ordinary skilled in the art to which the present invention belongs. The terms “first”, “second” and the like in the Description and the Claims of the present application for invention do not mean any sequential order, number or importance, but are only used for distinguishing different components. The terms “a”, “an” and the like do not denote a limitation of quantity, but denote the existence of at least one. The terms “comprises”, “comprising”, “includes”, “including” and the like mean that the element or object in front of the “comprises”, “comprising”, “includes” and “including” cover the elements or objects and their equivalents illustrated following the “comprises”, “comprising”, “includes” and “including”, but do not exclude other elements or objects. The term “coupled” or “connected” or the like is not limited to being connected physically or mechanically, nor limited to being connected directly or indirectly.

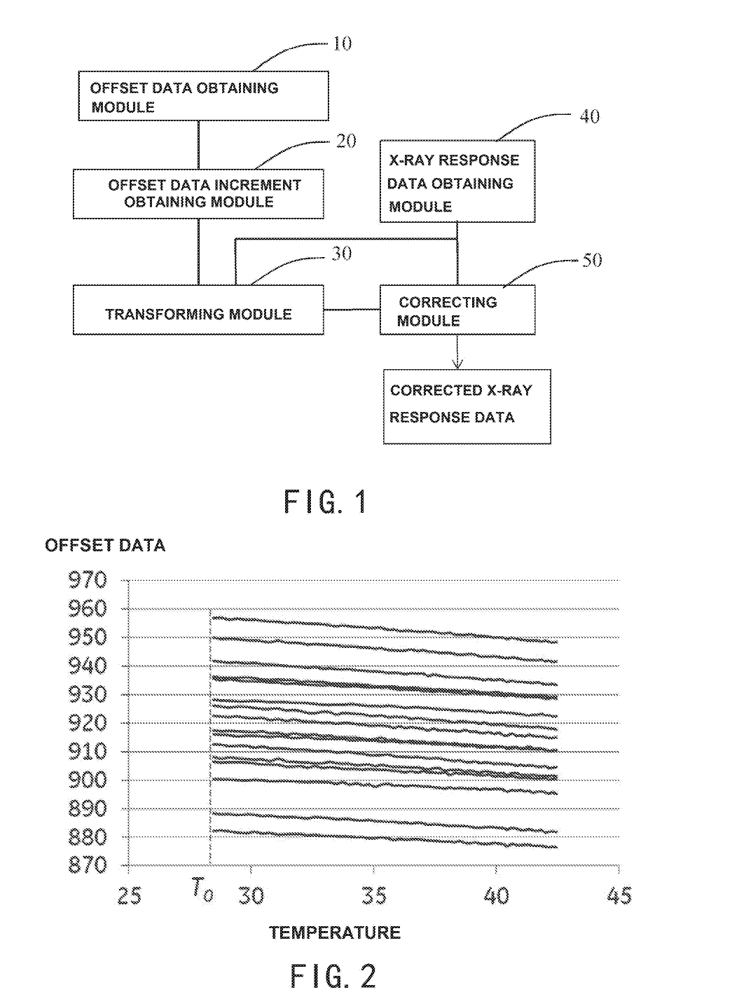

FIG. 1 is a block diagram of a system for temperature correction of an X-ray detector provided by one embodiment of the present invention. As shown in FIG. 1, the system comprises a offset data obtaining module 10, a offset data increment obtaining module 20, a transforming module 30, an X-ray response data obtaining module 40 and a correcting module 50.

The offset data obtaining module 10 is used to obtain offset data “offset” of each pixel unit of the X-ray detector at a current temperature.

The offset data increment obtaining module 20 is used to subtract calibration offset data offset0 of each pixel unit at a preset temperature T0 from the offset data “offset” of the pixel unit at the current temperature to obtain a current offset data increment Δoffset of each unit. The preset temperature T0 may be understood as a base temperature, a calibration temperature or a reference temperature, e.g., a temperature of a pixel unit of the detector set during a calibration experiment.

The offset data “offset” of each pixel unit at the current temperature is just offset data produced when the object to be scanned is human body, work piece and the like to be detected during the current scanning

The calibration offset data offset0 of a pixel unit at the preset temperature T0 is just offset data produced when material or air used for calibration, rather than human body or work piece to be detected, is served as the object to be scanned and the temperature of the pixel unit is the preset temperature T0, at the time of calibration experiment.

Therefore, in the embodiments of the present invention, to facilitate the understanding, data obtained during the calibration experiment is referred to as calibration data, and data obtained during the current scanning is referred to as current data.

The X-ray response data obtaining module 40 is used to obtain X-ray response data “gain” of the above each pixel unit under a preset scanning parameter condition at the current temperature (the object to be scanned is human body, work piece to be detected). The preset scanning parameter may include a voltage kV, a current mA, a scanning mode, a scanning time and the like of an X-ray source.

The transforming module 30 is used to obtain a current X-ray response data increment Δgain of each pixel unit based on a pre-stored transform function, wherein the transform function uses the current offset data increment of each pixel unit and the X-ray response data of each pixel unit at the current temperature as independent variables, and uses the current X-ray response data increment of each pixel unit as a dependent variable.

The correcting module 50 is used to obtain corrected X-ray response data gain′ of each pixel unit by subtracting the current X-ray response data increment Δgain of each pixel unit from the X-ray response data “gain” (in the temperature correction system and method flow, the object to be scanned is human body, work piece and the like to be detected) of each pixel unit at the current temperature. The corrected X-ray response data gain′ of each pixel unit is just X-ray response data that should be produced in the current scanning in case of no temperature shift being generated in the pixel unit of the detector.

Detailed explanations will be given for the data obtained by the respective modules as mentioned above in the following:

1, offset data of each pixel unit, which is a signal of the detector without irradiation of rays, i.e., a signal of the pixel unit acquired without an X-ray exposure, for example, the offset data “offset” of one pixel unit at the current temperature is a signal acquired without an X-ray exposure at the current temperature (e.g., the actual temperature during scanning), the current temperature of the pixel unit generally being different from its preset temperature because of temperature shift due to material property and the like;

2, current offset data increment offset Δoffset of each pixel unit, which is an increment of the offset data “offset” of the pixel unit at its current temperature relative to the calibration offset data offset0 at the preset temperature T0;

3, current X-ray response data “gain” of each pixel unit, which is a signal of the pixel unit acquired with the X-ray exposure at the current temperature, during the current scanning in which human body or work piece to be detected is served as the object to be scanned; 4, current X-ray response data increment Δgain of each pixel unit, which theoretically is a difference value of the X-ray response data “gain” of each pixel unit at the current temperature relative to the calibration X-ray response data gain0 at its preset temperature T0; calibration X-ray response data gain0 of each pixel unit at the preset temperature T0, which is X-ray response data obtained when the calibration experiment is performed; the calibration X-ray response data gain0 of each pixel unit at the preset temperature T0 being applied into the flow for determining the transform function below.

Detailed introduction will be given in the following about the specific principles as to how to determine the transform function and make temperature correction using the determined transform function:

FIG. 2 is a schematic diagram showing that offset data of each pixel unit of the X-ray detector changes as the temperature of the pixel unit changes. As shown in FIG. 2, through research, it can be found that when the X-ray medical scanning is performed, the offset data of each pixel unit changes linearly as the temperature changes, so the following may be given:

Δoffseti=ΘΔTi, (1)

wherein Δoffseti is an increment of the calibration offset data offseti of a pixel unit of the X-ray detector at a non-preset temperature Ti (Ti≠T0) relative to the calibration offset data offset0 of the pixel unit at the preset temperature T0, η is a constant, ΔTi is an increment of the non-preset temperature Ti relative to the preset temperature T0.

From the above Equation (1), it can be seen that the temperature increment ΔTi may be represented by the calibration offset data increment Δoffseti, i.e.,:

$$Δ Ti = \frac{1}{η} Δ offseti \qquad ( 2 )$$

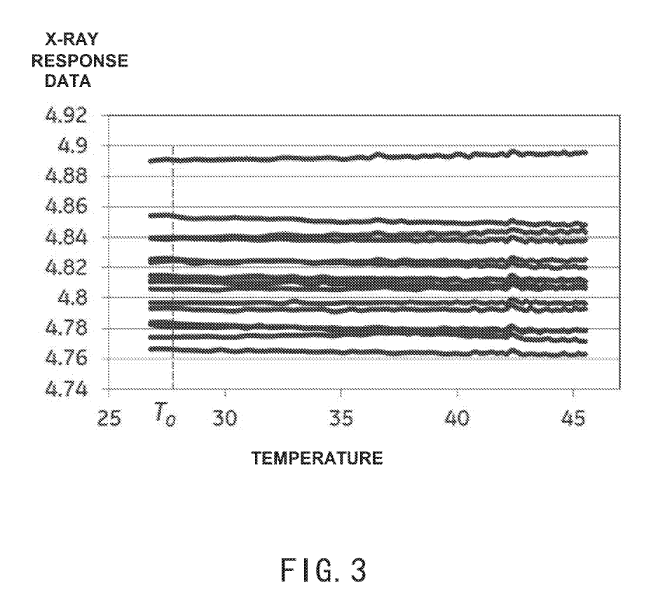

FIG. 3 is a schematic diagram showing that X-ray response data of each pixel unit of the X-ray detector changes as the temperature of the pixel unit changes. As shown in FIG. 3, since the X-ray response data of each pixel unit of the detector changes as the temperature of the pixel unit changes, in one example, the relationship of change may be expressed in:

Δgaini=f(gaini, a′+b′*ΔTi+c′*ΔTi²)) (3)

wherein Δgaini is an increment of the calibration X-ray response data “gaini” of the pixel unit of the X-ray detector at the non-preset temperature Ti relative to the calibration X-ray response data gain0 of the pixel unit at the preset temperature T0, a′, b′, c′ are all constants.

Based on the above Equations (2) and (3), the relationship between the calibration X-ray response data increment Δgaini and the temperature increment ΔTi may be expressed by the relationship between the calibration X-ray response data increment Δgaini, the calibration X-ray response data “gaini” and the calibration offset data increment Δoffseti, and a transform function may be established by fitting multiple sets of data at multiple non-preset temperatures (each set of data includes calibration X-ray response data increment Δgaini, calibration X-ray response data “gaini” and calibration offset data increment Δoffseti), the transform function using the offset data increment (during the temperature correction, the offset data increment is just the current offset data increment of the pixel unit) and the X-ray response data (during the temperature correction, the X-ray response data is just X-ray response data of the pixel unit at the current temperature) of the pixel unit as independent variables, using the X-ray response data increment (during the temperature correction, the X-ray response data increment is just the current X-ray response data increment of the pixel unit) as a dependent variable, the transform function being expressed in:

Δgain=f(gain, Δoffset) (4)

wherein Δgain is the current X-ray response data increment of each pixel unit, “gain” is the X-ray response data of each pixel unit at the current temperature, Δoffset is the current offset data increment of each pixel unit.

Therefore, when correcting the problem of image signal shift due to temperature shift, the current offset data increment Δoffset of each pixel unit obtained by the offset data increment obtaining module 20 and the X-ray response data “gain” of each pixel unit at the current temperature obtained by the X-ray response data obtaining module 40 may be substituted into the above Equation (4), the current X-ray response data increment Δgain of each pixel unit is obtained by carrying out the algorithm of the above Equation (4), and the current X-ray response data increment Δgain is subtracted from the current X-ray response data “gain”, thereby a corrected X-ray response data gain′ may just be obtained, i.e.,

gain′=gain−Δgain (5)

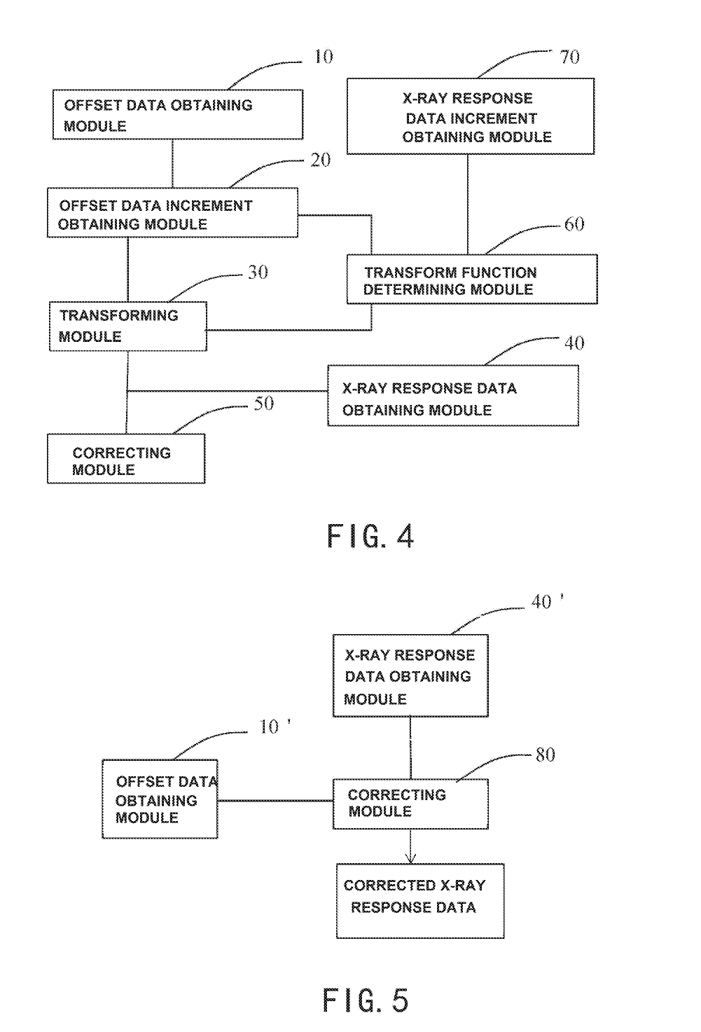

FIG. 4 is a block diagram of a system for temperature correction of an X-ray detector provided by another embodiment of the present invention. As shown in FIG. 4, in order to determine a suitable transform function, the system for temperature correction of an X-ray detector of the embodiments of the present invention further comprises a transform function determining module 60 and an X-ray response data increment obtaining module 70, and the respective modules in the embodiments of the present invention further carry out the following actions:

the offset data obtaining module 10 is further used to obtain calibration offset data “offseti” of each pixel unit at the at least one non-preset temperature Ti;

the offset data increment obtaining module 20 is further used to subtract the calibration offset data offset0 of each pixel unit at the preset temperature T0 from the calibration offset data “offseti” of the pixel unit at the at least one non-preset temperature Ti to get a calibration offset data increment Δoffseti of each pixel unit at the at least one non-preset temperature Ti;

the X-ray response data increment obtaining module 70 is used to obtain a difference value between the calibration X-ray response data “gaini” of each pixel unit at the at least one non-preset temperature Ti and the calibration X-ray response data gain0 of each pixel unit at the preset temperature T0 (when applied into the flow of determining the transform function, the object to be scanned is human body not to be detected), and to use said difference value as a calibration X-ray response data increment Δgaini of each pixel unit at the at least one non-preset temperature Ti;

the transform function determining module 60 is used to determine the above transform function (4) based on a correspondence relationship between the calibration offset data increment Δoffseti, the calibration X-ray response data “gaini” and the calibration X-ray response data increment Δgaini of each pixel unit at the at least one non-preset temperature Ti.

Optionally, in order to make temperature correction of the X-ray detector more accurately, the calibration offset data offseti of each pixel unit at the at lease one non-preset temperature Ti is an average of a plurality of calibration offset data obtained in a plurality of scans, and the calibration X-ray response data “gaini” of each pixel unit at the at lease one non-preset temperature is an average of a plurality of calibration X-ray response data obtained in the above plurality of scans.

In one embodiment, the above transform function (4) may specifically be determined as:

Δgain=f(gain, a+b*Δoffset) (6)

In order to make the temperature correction of the X-ray detector more accurately, the above transform function (4) may be further expressed as:

Δgain=f(gain, a+b*Δoffset+c*Δoffset²) (7)

In the above Equations (6) and (7), a, b and c are all constants.

In particular, the values of a, b and c may be obtained by fitting the calibration X-ray response data increment Δgaini, the calibration offset data increment Δoffseti and the calibration X-ray response data of each pixel unit at the at least one non-preset temperature and the above transform function (6) or (7).

FIG. 5 is a block diagram of a system for temperature correction of an X-ray detector provided by another embodiment of the present invention. Using the above Equation (4), the X-ray response data increment Δgain of the pixel unit of the detector at the current temperature may be obtained, and the corrected X-ray response data gain′ may be obtained by subtracting the increment from the current measured X-ray response data. In the present embodiment, the above Equation (4) may be transformed according to the above principle, to directly obtain the corrected X-ray response data gain′ of the pixel unit by using the offset data and the X-ray response data of the pixel unit at the current temperature as independent variables directly, the principle of which is as follows:

From the above Equation (4), the following may be obtained:

(gain−gain′)=f(gain, offset−offset0) (8),

wherein offset0 is calibration offset data of a pixel unit at a preset temperature, which is a known fixed value; “offset” is offset data of the pixel unit at a non-preset temperature, which is offset data of the pixel unit at the current temperature measured at the time of the current scan; “gain” is X-ray response data at the current temperature measured at the time of the current scan; gain′ is corrected X-ray response data to be obtained at the time of the current scan (i.e., X-ray response data obtained in case of no temperature shift being generated in the pixel unit at the time of the current scan).

Since offset0 is a fixed value, according to the above Equation (8), a transform function using the offset data “offset” and the X-ray response data “gain” of each pixel unit at the current temperature as independent variables and using the corrected X-ray response data gain′ of each pixel unit as a dependent variable may be obtained:

gain′=gain−f′(gain, offset) (9).

Therefore, the system for temperature correction of an X-ray detector of the present embodiment comprises a offset data obtaining module 10′, an X-ray response data obtaining module 40′ and a correcting module 80.

The offset data obtaining module 10′ is used to obtain offset data “offset” of each pixel unit of the X-ray detector at the current temperature; the X-ray response data obtaining module 40′ is used to obtain X-ray response data “gain” of each pixel unit with a preset scanning parameter at the current temperature; the correcting module 80 is used to obtain the corrected X-ray response data gain′ of each pixel unit according to the pre-stored transform function (9), i.e., X-ray response data thereof at the preset temperature. Specifically, the above transform function (9) uses the offset data “offset” and the X-ray response data “gain” of each pixel unit at the current temperature as independent variables, and uses the corrected X-ray response data gain′ of each pixel unit as a dependent variable.

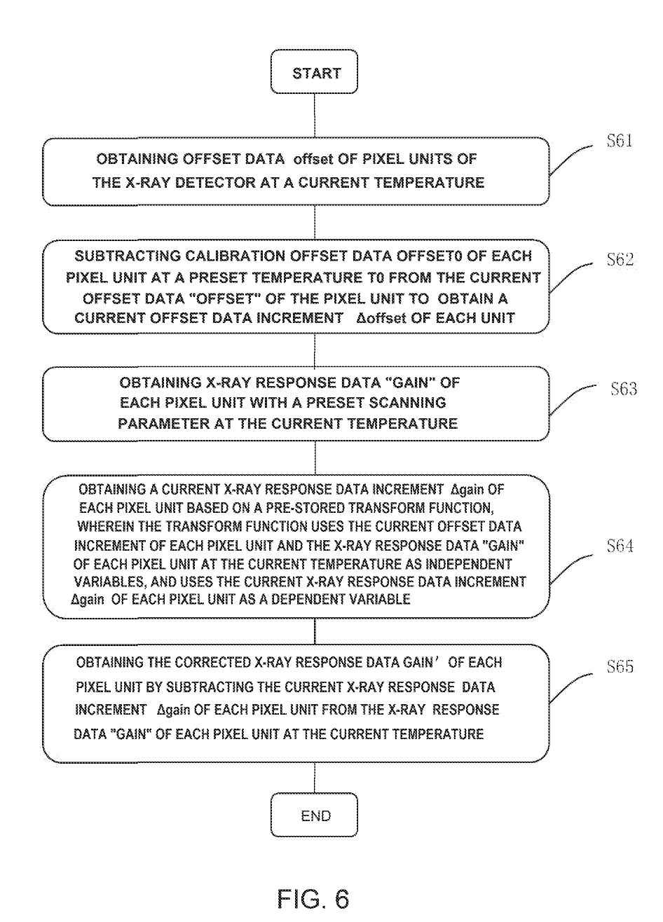

FIG. 6 is a flow chart of a method for temperature correction of an X-ray detector provided by one embodiment of the present invention. As shown in FIG. 6, the method comprises the following steps:

Step S61: obtaining offset data of pixel units of the X-ray detector at a current temperature;

Step S62: subtracting calibration offset data offset0 of each pixel unit at a preset temperature T0 from the offset data “offset” of the pixel unit at the current temperature to obtain a current offset data increment Δoffset of each unit;

Step S63: obtaining X-ray response data “gain” of each pixel unit with a preset scanning parameter at the current temperature;

Step S64: obtaining a current X-ray response data increment Δgain of each pixel unit based on a pre-stored transform function, wherein the transform function uses the current offset data increment Δoffset of each pixel unit and the X-ray response data “gain” of each pixel unit at the current temperature as independent variables, and uses the current X-ray response data increment Δgain of each pixel unit as a dependent variable;

Step S65: obtaining the corrected X-ray response data gain′ of each pixel unit by subtracting the current X-ray response data increment Δgain of each pixel unit from the X-ray response data “gain” of each pixel unit at the current temperature.

Specifically, the above embodiment of the method for temperature correction of an X-ray detector may be carried out by the system for temperature correction of an X-ray detector as shown in the figures, for example, carrying out Steps S61-S65 by the offset data obtaining module 10, the offset data increment obtaining module 20, the X-ray response data obtaining module 40, the transforming module 30 and the correcting module 50.

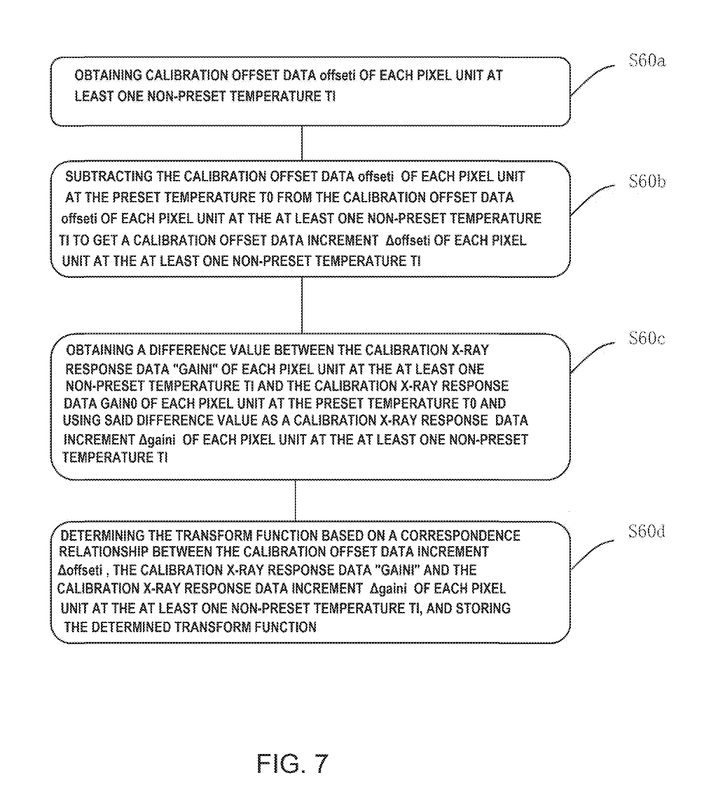

Optionally, before Step S64, steps of obtaining a transform function may also be comprised. FIG. 7 is a flow chart of obtaining a transform function before Step S64 in FIG. 6. As shown in FIG. 7, obtaining a transform function specifically comprises Steps S60a-S60d:

Step S60a: calibration offset data offseti of each pixel unit at the at least one non-preset temperature Ti is obtained; for example, in the present step, the calibration offset data offseti of each pixel unit at the at least one non-preset temperature Ti is obtained by the offset data obtaining module 10.

Step S60b: the calibration offset data offset0 of each pixel unit at the preset temperature T0 is subtracted from the calibration offset data offseti of each pixel unit at the at least one non-preset temperature Ti to get a calibration offset data increment Δoffseti of each pixel unit at the at least one non-preset temperature Ti; the present step may be carried out by the offset data increment obtaining module 20.

Step S60c: a difference value (gaini-gain0) between the calibration X-ray response data “gaini” of each pixel unit at the at least one non-preset temperature Ti and the calibration X-ray response data gain0 of each pixel unit at the preset temperature T0 is obtained, and said difference value is used as a calibration X-ray response data increment Δgaini of each pixel unit at the at least one non-preset temperature Ti; this step may be carried out by the X-ray response data increment (the object to be scanned is material or air used for determining the transform function, rather than human body to be detected) obtaining module 70.

Step S60d: the above transform function is determined based on a correspondence relationship between the calibration offset data increment Δoffseti, the calibration X-ray response data “gaini” and the calibration X-ray response data increment Δgaini of each pixel unit at the at least one non-preset temperature Ti, and the determined transform function is stored. This step may be carried out by the transform function determining module 60.

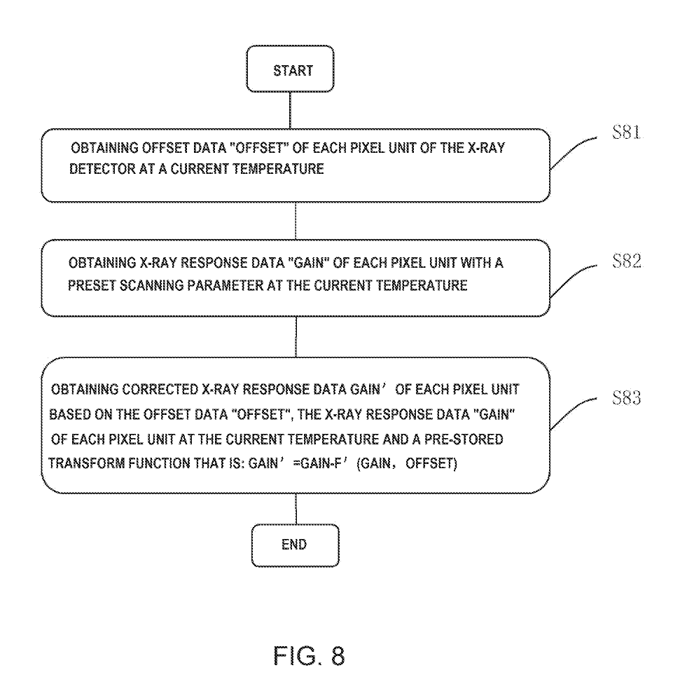

FIG. 8 is a flow chart of a method for temperature correction of an X-ray detector provided by another embodiment of the present invention. As shown in FIG. 8, the method comprises the following steps:

Step S81: obtaining offset data “offset” of each pixel unit of the X-ray detector at a current temperature;

Step S82: obtaining X-ray response data “gain” of each pixel unit with a preset scanning parameter at the current temperature;

Step S83: obtaining corrected X-ray response data gain′ of each pixel unit based on a pre-stored transform function (9).

Specifically, the method for temperature correction of an X-ray detector as shown in FIG. 8 may be carried out by the system for temperature correction of an X-ray detector as shown in FIG. 5, for example, carrying out Steps S81-S83 by the offset data obtaining module 10′, the offset X-ray response data obtaining module 40′ and the correcting module 80.

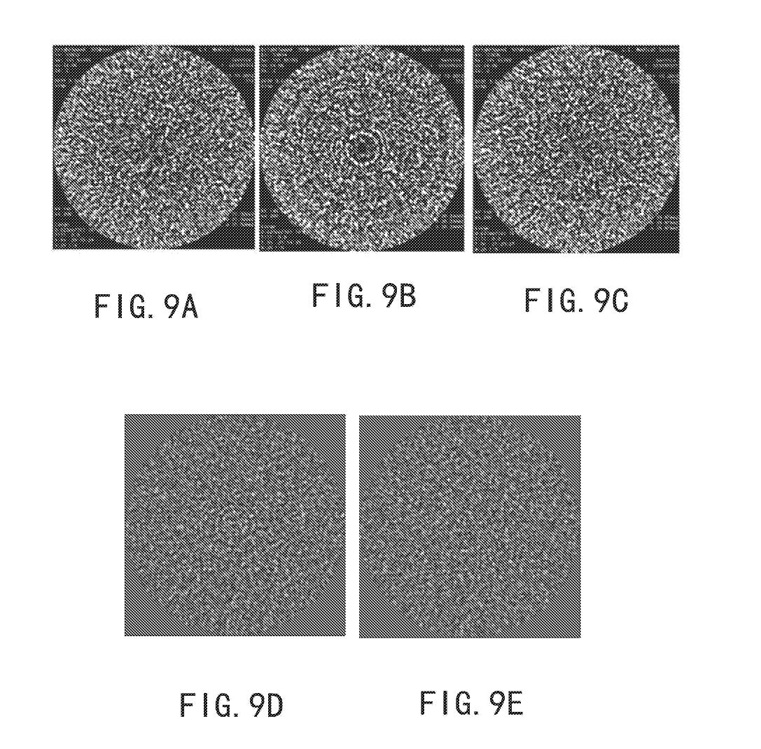

FIGS. 9A-9E are comparison diagrams between images obtained after temperature correction using the above system and method for temperature correction of an X-ray detector and images obtained after conventional temperature correction. Specifically, FIG. 9A illustrates an image obtained by the detector at a normal temperature 26° C. (e.g., the above preset temperature); FIG. 9B illustrates an image obtained by the detector at a temperature of 46° C. with no temperature correction; FIG. 9C illustrates an image obtained by the detector at the temperature of 46° C. after temperature correction using the system and method for temperature correction of the present invention; FIG. 9D illustrates an image obtained by subtracting the image data in FIG. 9A from the image data in FIG. 9B; FIG. 9E illustrates an image obtained by subtracting the image data in FIG. 9A from the image data in FIG. 9C; From FIGS. 9B and 9D, it can be seen that when performing a temperature correction without using the system and method for temperature correction of the present invention, the obtained image has an obvious artifact (positioned at a center portion of the image). From FIGS. 9C and 9E, it can be seen that after a temperature correction by using the present invention, the image artifact is removed, with a little difference from the image at the normal temperature (FIG. 9A).

The system and method for temperature correction of an X-ray detector in the embodiments of the present invention are capable of removing artifacts effectively and enhancing image qualities, by determining the current X-ray response data increment using the obtained offset data increment and subtracting the current X-ray response data increment from the current X-ray response data to obtain the image data of each pixel unit at a preset temperature. Compared with the conventional temperature control method, errors due to differences between temperature sensor devices may be reduced, and the cost is low, without using temperature sensor, cable, data reading apparatus or the like.

The person skilled in the art should understand that although the above embodiments of the present invention only illustratively describe a manner for obtaining corrected X-ray response data using two kinds of transform functions, their principles all make use of translating a relationship between a temperature shift (temperature increment) and a change of X-ray response data that would otherwise need to be measured to a relationship between a change of intermediate data (for example, offset data increment changing as temperature changes, offset data changing as temperature changes, X-ray response data increment changing as temperature changes, X-ray response data changing as temperature changes) and a change of corrected X-ray response data, thus avoiding a direct measurement of temperature shift but establishing a transform function by using the intermediate data as independent variables, and finally obtaining corrected X-ray response data. Therefore, even if any change in form is made to the above transform function, all methods for obtaining corrected X-ray response data by using intermediate data between offset data of temperature shift and corrected X-ray response data as variables should be regarded as falling within the protection range of the present invention.

Some exemplary embodiments have been described in the above. However, it should be understood that various modifications may be made thereto. For example, if the described techniques are carried out in different orders, and/or if the components in the described system, architecture, apparatus or circuit are combined in different ways and/or replaced or supplemented by additional components or equivalents thereof, proper results may still be achieved. Accordingly, other embodiments are also falling within the protection scope of the claims.

Implementations of the present invention onto a CT detector, an X-ray flat panel detector, an industrial CT detector, an industrial X-ray flat panel detector and a photo diode array detector also fall within the protection range of the present invention.

What is claimed is:

1. A temperature correction system for an X-ray detector, the system comprising:
an offset data obtaining module for obtaining offset data of pixel units of the X-ray detector at a current temperature;
an offset data increment obtaining module for subtracting calibration offset data of each of the pixel units at a preset temperature from the offset data of the pixel unit at the current temperature to obtain a current offset data increment of the each pixel unit;
an X-ray response data obtaining module for obtaining X-ray response data of the each pixel unit with a preset scanning parameter at the current temperature;
a transforming module for obtaining a current X-ray response data increment of the each pixel unit based on a pre-stored transform function, wherein the transform function uses the current offset data increment of the each pixel unit and the X-ray response data of the each pixel unit at the current temperature as independent variables, and uses the current X-ray response data increment of the each pixel unit as a dependent variable; and
a correcting module for obtaining corrected X-ray response data of the each pixel unit by subtracting the current X-ray response data increment of the each pixel unit from the X-ray response data of the each pixel unit at the current temperature.

2. The temperature correction system for an X-ray detector according to claim 1, wherein said temperature correction system for an X-ray detector further comprises an X-ray response data increment obtaining module and a transform function determining module;
the offset data obtaining module is further to obtain calibration offset data of the each pixel unit at at least one non-preset temperature;
the offset data increment obtaining module is further to subtract the calibration offset data of the each pixel unit at the preset temperature from the calibration offset data of the each pixel unit at the at least one non-preset temperature to get a calibration offset data increment of the each pixel unit at the at least one non-preset temperature;
the X-ray response data increment obtaining module is to obtain a difference value between calibration X-ray response data of the each pixel unit at the at least one non-preset temperature and calibration X-ray response data of the each pixel unit at the preset temperature, and to use said difference value as a calibration X-ray response data increment of the each pixel unit at the at least one non-preset temperature;
the transform function determining module is to determine the transform function based on a correspondence relationship between the calibration offset data increment, the calibration X-ray response data and the calibration X-ray response data increment of the each pixel unit at the at least one non-preset temperature, and to store the determined transform function.

3. The temperature correction system for an X-ray detector according to claim 2, wherein the calibration offset data of the each pixel unit at the at lease one non-preset temperature is an average of a plurality of calibration offset data obtained respectively in a plurality of scans, and the calibration X-ray response data of the each pixel unit at the at lease one non-preset temperature is an average of a plurality of calibration X-ray response data obtained respectively in the plurality of scans.

4. The temperature correction system for an X-ray detector according to claim 1, wherein said transform function is:
Δgain=gain*(a+b*Δoffset),
wherein Δgain is the current X-ray response data increment of the each pixel unit, “gain” is the X-ray response data of the each pixel unit at the current temperature, Δoffset is the current offset data increment of the each pixel unit, a and b are both constants.

5. The temperature correction system for an X-ray detector according to claim 1, wherein said transform function is:
Δgain=gain*(a+b*Δoffset+c*Δoffset²),
wherein is the current X-ray response data increment of the each pixel unit, “gain” is the X-ray response data of the each pixel unit at the current temperature, Δoffset is the current offset data increment of the each pixel unit, a, b and c are all constants.

6. A temperature correction method for an X-ray detector, the method comprising:
obtaining offset data of pixel units of the X-ray detector at a current temperature;
subtracting calibration offset data of each of the pixel units at a preset temperature from the offset data of the pixel unit at the current temperature to obtain a current offset data increment of the each pixel unit;
obtaining X-ray response data of the each pixel unit with a preset scanning parameter at the current temperature;
obtaining a current X-ray response data increment of the each pixel unit based on a pre-stored transform function, wherein the transform function uses the current offset data increment of the each pixel unit and the X-ray response data of the each pixel unit at the current temperature as independent variables, and uses the current X-ray response data increment of the each pixel unit as a dependent variable; and
obtaining corrected X-ray response data of the each pixel unit by subtracting the current X-ray response data increment of the each pixel unit from the X-ray response data of the each pixel unit at the current temperature.

7. The temperature correction method for an X-ray detector according to claim 6, wherein before the step of obtaining a current X-ray response data increment of the each pixel unit based on a pre-stored transform function, the following steps are further comprised:
obtaining calibration offset data of the each pixel unit at at least one non-preset temperature;
subtracting the calibration offset data of the each pixel unit at the preset temperature from the calibration offset data of the each pixel unit at the at least one non-preset temperature to get a calibration offset data increment of the each pixel unit at the at least one non-preset temperature;
obtaining a difference value between calibration X-ray response data of the each pixel unit at the at least one non-preset temperature and calibration X-ray response data of the each pixel unit at the preset temperature, and using said difference value as a calibration X-ray response data increment of the each pixel unit at the at least one non-preset temperature; and
determining the transform function based on a correspondence relationship between the calibration offset data increment, the calibration X-ray response data and the calibration X-ray response data increment of the each pixel unit at the at least one non-preset temperature, and storing the determined transform function.

8. The temperature correction method for an X-ray detector according to claim 7, wherein the calibration offset data of the each pixel unit at the at lease one non-preset temperature is an average of a plurality of calibration offset data obtained respectively in a plurality of scans, and the calibration X-ray response data of the each pixel unit at the at lease one non-preset temperature is an average of a plurality of calibration X-ray response data obtained respectively in the plurality of scans.

9. The temperature correction method for an X-ray detector according to claim 6, wherein said transform function is:
Δgain=gain*(a+b*Δoffset),
wherein Δgain is the current X-ray response data increment of the each pixel unit, “gain” is the X-ray response data of the each pixel unit at the current temperature, Δoffset is the current offset data increment of the each pixel unit, a and b are both constants.

10. The temperature correction method for an X-ray detector according to claim 6, wherein said transform function is:
Δgain=gain*(a+b*Δoffset+c*Δoffset²),
wherein Δgain is the current X-ray response data increment of the each pixel unit, “gain” is the X-ray response data of the each pixel unit at the current temperature, Δoffset is the current offset data increment of the each pixel unit, a, b and c are all constants.

11. A temperature correction system for an X-ray detector, the system comprising:
an offset data obtaining module for obtaining offset data of pixel units of the X-ray detector at a current temperature;
an X-ray response data obtaining module for obtaining X-ray response data of each of the pixel units with a preset scanning parameter at the current temperature; and
a correcting module for obtaining corrected X-ray response data of the each pixel unit based on a pre-stored transform function, wherein the transform function is: gain′=gain−f′ (gain, offset), wherein gain′ is the corrected X-ray response data of the each pixel unit, “gain” is the X-ray response data of the each pixel unit at the current temperature, “offset” is the offset data of the each pixel unit at the current temperature.

12. A temperature correction method for an X-ray detector, the method comprising:
obtaining offset data of pixel units of the X-ray detector at a current temperature;
obtaining X-ray response data of each of the pixel units with a preset scanning parameter at the current temperature; and
obtaining corrected X-ray response data of the each pixel unit based on a pre-stored transform function, wherein the transform function is: gain′=gain−f′ (gain, offset), wherein gain′ is the corrected X-ray response data of the each pixel unit, “gain” is the X-ray response data of the each pixel unit at the current temperature, “offset” is the offset data of the each pixel unit at the current temperature.
